(19) United States
(12) Patent Application Publication
(10) Pub. No.: US 2006/0153167 A1
(43) Pub. Date: Jul. 13, 2006

(54) Computer tracking and locking

(76) Inventor: Alan J. Schunemann, Annapolis, MD (US)

Correspondence Address: DLA PIPER RUDNICK GRAY CARY US LLP, P. O. BOX 9271, RESTON, VA, 20195, US

(21) Appl. No.: 11/283,046

(22) Filed: Nov. 21, 2005

Related U.S. Application Data
(60) Provisional application No. 60/629,303, filed on Nov. 19, 2004.

(51) Int. Cl. H04L 12/66; H04L 12/56

(52) U.S. Cl. 370/352; 370/395.54

(57) ABSTRACT

A method and system are provided for locating a device connected to a network. The method comprises querying the network to determine an address of the device connected to the network; accessing network address information to determine a switch IP address and a switch port associated with the address of the device; and correlating the switch IP address and switch port with a physical location of the device within the network.

This application is based on and derives the benefit of the filing date of U.S. Provisional Patent Application No. 60/629,303 filed Nov. 19, 2004, the contents of which are incorporated herein by reference.

### FIELD OF THE INVENTION

The present invention relates generally to computer networking environments, and relates specifically to a method and system for tracking or locating a device, such as a computer, in a network.

### BRIEF DESCRIPTION OF THE DRAWINGS

FIG. 1 is a schematic network system diagram, according to an embodiment of the present invention; and

FIGS. 2-3 are flow charts showing the various steps in the process performed for locating or tracking a device in a network, according to an embodiment of the present invention. FIG. 2 shows a flow of the translation of a phone number to a location, and FIG. 3 shows the flow of crawling the network to create a device map.

### DESCRIPTION OF EMBODIMENTS OF THE INVENTION

A method and system to physically locate a device in a network, according to an embodiment of the invention, is described herein. The device may be a computer such as a desktop computer or a laptop computer, a personal digital assistant (PDA), a telephone set, a fax machine, a printer, an audio device, a video device, etc.

A computer when connected to a network can be used, for example, for sending audio signals such as voice signals over the network to other computers or other devices connected to the network. The routing of voice signals over the network, such as the internet or other IP-based networks, involves the use of voice over IP (VoIP) protocols. VoIP traffic may be deployed on any IP network such as the internet and other networks, such as on a private building wide local area network (LAN).

Each device on a network has a media access control address. The address can be the MAC address 125 or the IP address 126. The MAC address 125 is a unique identifier attached to most forms of networking devices and equipment. A MAC address 125, permanently attached to the device by the manufacturer of the device, is often referred to as burned-in address (BIA) or as a universally administered address (UAA). The BIA or UAA can be overridden with a locally administered address (LAA). The LAA is assigned to the device by the network administrator instead of the device manufacturer. For example, a common format in printing MAC addresses 125 is six groups of two hexadecimal digits, separated by colons (:) or hyphens (-). A device when linked to a network in a network environment may also be uniquely identified by an IP address.

In the following description, the device connected to the network may be referred to as VoIP device or VoIP phone, interchangeably. However, the device is limited neither to a VoIP device nor a VoIP phone but encompasses any device that can be connected to a network, including, but not limited to, a computer, a personal digital assistant (PDA), a printer, a fax machine, an audio device, a video device or the like.

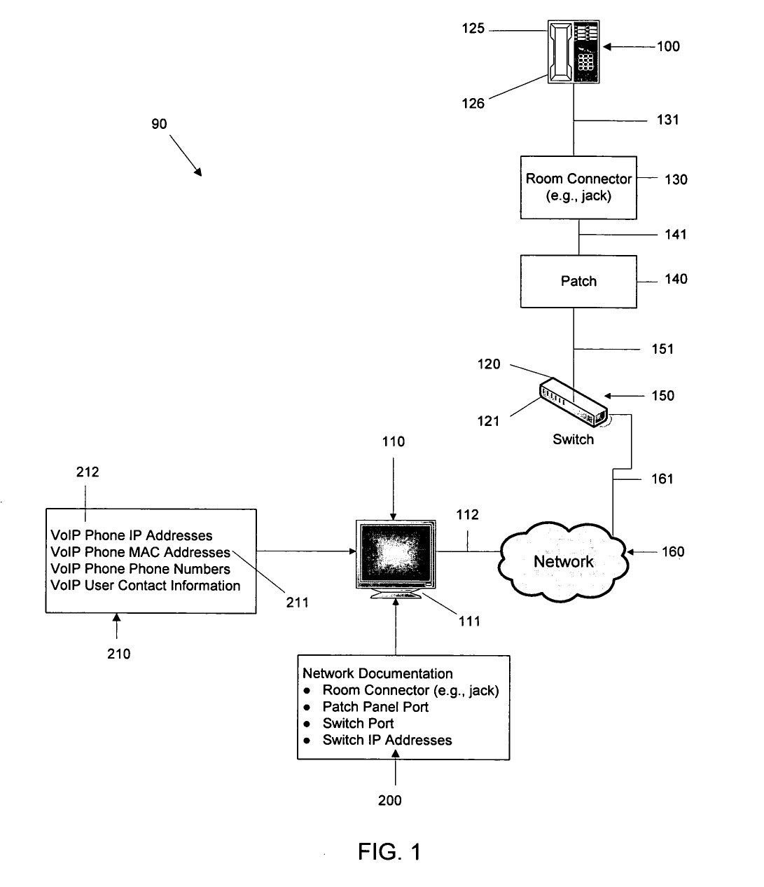

FIG. 1 is a schematic network system diagram, according to an embodiment of the present invention. The network system diagram 90 illustrates a device 100 (for example, a VoIP phone) connected to a room connector 130 (e.g., room jack or access point connector) via line 131. The room connector 130 can be any connector that allows the device to be connected to a communication line. The room connector 130 can be any connector including, but not limited to, a telephone jack, a BNC connector, an ethernet connector, and access point connector, or the like. The location of the room connector 130 can determine a physical location of device 100 in a building. The room connector 130 is connected to patch panel port 140 via line 141. The patch panel port 140 is a panel of network ports. The network ports are interfaces through which data is transferred and can be contained together in a rack. The network ports are used to connect incoming and outgoing lines in a network or other communication, electronic or electrical systems. The patch panel port 140 allows the incoming and outgoing lines to be arranged and rearranged by plugging and unplugging patch cords. The patch panel port 140 is connected to a switch 150 via line 151. The switch 150 is a computer networking device that connects network segments and controls routing. It is often used to replace network hubs. A switch is also often referred to as an intelligent hub. The switch 150 is in turn connected to network 160 via line 161. In a non-traditionally configured network it is possible that a jack would be directly plugged into a switch, thus excluding a patch panel port 140, also a computer could be plugged directly into a switch, thus excluding a jack and patch.

The device 100 has a MAC address 125 and may be assigned an associated IP address 126 when connected to the network 160. As a data frame or data packet is sent from a device 100 through switch 150, the switch 150 records the originating MAC address 125 of device 100, the originating IP address 126 of device 100, and the switch port 120 through which the data frame or data packet entered the switch 150. A device 100 may be commonly identified by other means (e.g., a phone number). Since the MAC address 125 or IP address 126 of the device 100 is required to locate the phone, the common identifier (e.g., phone number) must be translated to a MAC address 125 or IP address 126 by referencing a source that lists devices and their IP addresses or MAC addresses (e.g., VoIP Phone List 210, or VoIP Server Logs).

The MAC address 125 of device 100, the IP address 126 of device 100 and the switch port 120, to which the device is connected, can be obtained from a network switch 150 by using simple network management protocol (SNMP). SNMP protocol works by sending messages, called protocol data units (PDUs), to different parts of a network and SNMP-compliant devices, which store data about themselves in management information bases (MIBs) (databases of objects), and return the data to SNMP requesters. This can be accomplished using a computer system 110.

The computer system 110 is connected to the network 160 via line 112. The computer system 110 runs a program code based on SNMP protocol which is executed to determine or capture the mappings from a network switch 150. The program code could be based on proprietary/vendor specific switch communication protocols. Hence, by running the program code to collect mappings from all switches, the computer 110 can capture, for each device on the network, a MAC address 125, an IP address 126, a switch port 120 to which the device is connected, and the switch IP address 121 to which the switch port 120 belongs, which is stored in network switch mappings 151. This information can be collected and compared with network documentation 200 to determine where each device is physically located.

The network documentation 200 is stored in a memory 111 of computer 110. The network documentation 200 includes at least a switch IP address 121, a switch port 120, and physical location of where switch IP address 121's switch port 120 is connected in the physical infrastructure (e.g., building and room). The network documentation may also contain other network information such as the patch panel port 140, the room connector 130, and the physical location of the room connector 130 in the network. Hence, by joining the switch port 120 and the switch IP address 121 for a device 100 in the network switch mappings 151 with a switch IP address 121 and switch port 120 in network documentation 200, the location of device 100 can be determined.

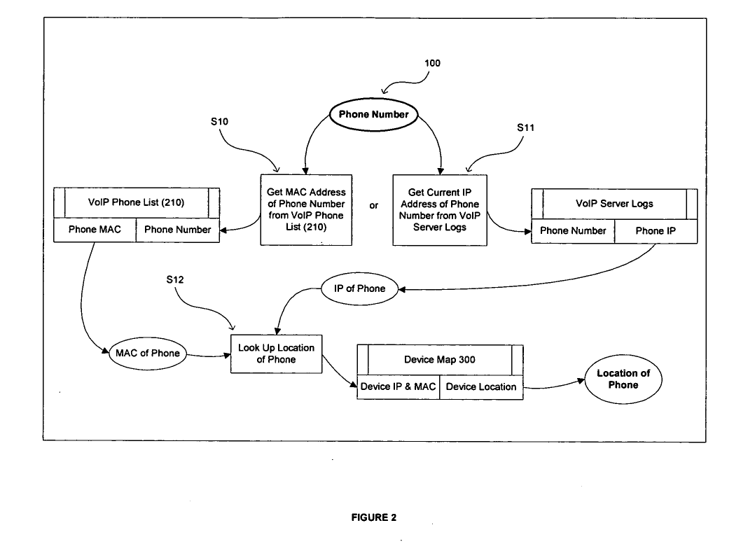

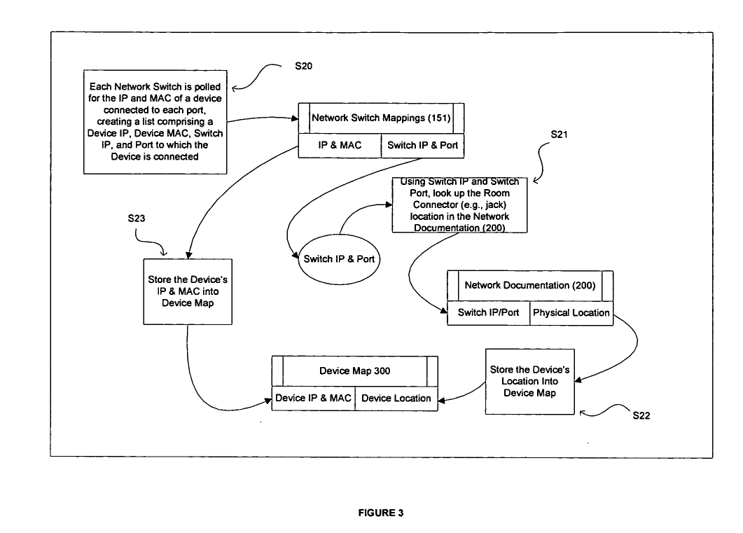

The location of each device on the network is stored in memory into device mappings 300 (see FIGS. 2 and 3), which correlate the IP address 126 and the MAC address 125 of the device 100 to the physical location of device 100. By periodically polling the network switches 150 for port mappings using SNMP or vendor specific switch management software to update network switch mappings 151 and joining network switch mappings 151 with network documentation 200, the device mappings 300 is kept up to date, therefore detecting when devices move.

In this way, device location policy can be established with the use of the program code. For example, a rule may be set up in the program code such that if the device 100 moves from its intended location and attempts to connect at another location in the network (e.g., a user moves a phone to another room), the computer system 110 can issue an SNMP “SET” command to disable or lock the new port and send an alert to appropriate support staff or the network administrator. A rule may also be set up in the program code such that if a new device (e.g., a personal phone brought in by an employee), not listed in the device MAC address list 211 or device IP address list 212, attempts to connect to the network, the computer system 110 can also disable the switch port 120 to which the new device attempts to connect to and issue an alert to the network administrator or appropriate support staff. On the other hand, if movement of the device 100 to a different location in the network 160 is authorized, the data in the program on 110 can be updated to reflect the change of location of the device 100.

FIGS. 2-3 show the various steps in the process performed for locating or tracking a device in a network, according to an embodiment of the present invention. The program code includes a series of steps which query the network to determine the physical location of the device 100.

The process of FIG. 2 is executed when a request to locate a device (in this example, a VoIP phone) is made. To find the location of a device (e.g., a VoIP phone, a computer, a personal digital assistant, a telephone set, a fax machine, a video device, an audio device, a printer, etc.), a network address (either a MAC address 125 or an IP address 126) of the device 100 is required. This network address can be acquired from, for example, if the device is a phone identified by a phone number, a VoIP phone list of phone numbers and their network addresses S10, or from a VoIP server log S11, etc. In S12, the MAC address 125 and/or IP address 126 of the device determined by the above means is referenced in the device map 300 to determine its location.

FIG. 3 illustrates the flow of crawling the network to create device map 300. The process depicted in FIG. 3 executes continually. In step S20, the computer system 110 runs a program code that uses SNMP to poll each switch on the network for the IP address 126 and MAC address 125 of a device 100 connected to each switch port 120, creating a list comprising a device IP address, device MAC address 125, switch IP address 121, and switch port 120 to which the device is connected for all devices in the network (network switch mappings 151).

The network documentation 200 is stored in a memory 111 of computer 110. The network documentation 200 includes at least a switch IP address 121, a switch port 120, and a physical location. It may also contain other network information such as a room connector 130 (e.g., jack), patch panel port 140, etc. Hence, by joining the switch port 120 and the switch IP address 121 for a device 100 in the network switch mappings 151 with a switch IP address 121 and switch port 120 in network documentation 200, the location of device 100 can be determined. Table 1 below summarizes the information which is compared and correlated to determine the physical location of device 100.

TABLE 1

| VoIP Phone List (210) | Network Switches (150) | Network Documentation (200) |
|---|---|---|
| VoIP Phone Number | | |
| (e.g., 123- 456-7890) | | |
| VoIP MAC Address | MAC Address | |
| (e.g., 00 10 DC DE 61 68) | (e.g., 00 10 DC DE 61 68) | |
| VoIP IP Address | IP Address | |
| (192.168.100.85) | (192.168.100.85) | |
| | Switch Port | Switch Port |
| | (3) | (3) |
| | Switch IP address | Switch IP address |
| | (e.g., 10.1.100.15) | (e.g., 10.1.100.15) |
| | | Patch Panel Port |
| | | (e.g., 12-3) |
| | | Room Connector |
| | | (e.g., 12-3-23) |
| | | Building/Room |
| | | (Room 23,, Building 15) |

Column 1 in Table 1 is the device address list 210 (e.g., a VoIP phone list) including the VoIP phone number, the VoIP MAC address list and the device IP address list. The MAC address 125 and the IP address of the device are correlated with, respectively, the switch port 120 and the switch IP address 121, as shown in column 2 of Table 1. The switch port 120 and the switch IP address 121 are correlated with the patch panel port 140, as shown in column 3 of Table 1. The patch panel port 140 is correlated with the room connector 130 which is linked with a physical location (such as a room number in a building), as shown in column 3 of table 1. Hence starting with the phone number of a device in column 1 and using the method described herein, the location of the device (e.g., VoIP phone) can be determined.

In S22 and S23, the location of each device on the network is stored in memory into device mappings 300, which correlate the IP address 126 and the MAC address 125 of the device 100 to the physical location of device 100. By periodically polling the network switches 150 for port mappings using SNMP or vender specific switch management software to update network switch mappings 151 and joining network switch mappings 151 with network documentation 200, the device mappings 300 is kept up to date, therefore detecting when devices move.

In the following paragraphs, a method according to an embodiment of the present invention is described with reference to an example. In this example, the device to be located is a phone, and it is identified by its phone number. Referring to FIG. 2 in step S10, the MAC address 125 of the device to be located is acquired by referencing the VoIP phone list 210. The location of the device to be located is determined by referencing the device map 300. The device map 300 is created and updated by the process detailed below.

The device map 300 is created and maintained by the method illustrated in FIG. 3. For each switch 150 in the network (as listed in the network documentation, and/or discovered by neighbor discovery methods) the IP address and MAC address 125 of all devices connected to the switch 150 are requested via SNMP using OID RFC1213-MIB::at PhysAddress MIB. The Response from each switch is in the form:

RFC1213-MIB::atPhysAddress.1032.192.168.132.2=Hex-STRING:00 10 DC DE 61 68

RFC1213-MIB::atPhysAddress.1032.192.168.123.3=Hex-STRING:00 A0 CC E7 27 68

The hexadecimal strings at the far right correspond to the MAC addresses 125 of the devices connected to the network. The 4 rightmost integers as delimited by periods to the left of the equal sign represent the IP address corresponding to each MAC address 125.

For each MAC address 125 discovered on the switch, the hexadecimal value is converted to a decimal value. For example, hexadecimal 00 10 DC DE 61 68 VoIP Phone=decimal 0.16.220.222.97.104. This decimal string is appended to the SNMPv2-SMI::mib-2.17.4.3.1.2 OID as follows, SNMPv2-SMI::mib-2.17.4.3.1.2.+0.16.220.222.97.104 to obtain the following OID, SNMPv2-SMI::mib-2.17.4.3.1.2.016.220.222.97.104. When the switch is queried with this OID, it returns a bridge index number. The bridge index number is an internal organizational index represented by an integer (e.g., 7).

The bridge index number of each MAC address 125 can be resolved to an actual switch port 120 on each switch by referencing a series of reference OIDs in the Switch MIB. This process uses a bridge index number to interface index OID, and an interface index to interface description OID. The bridge index acquired in 0024 is used to acquire an interface index. The interface index number is an integer identifier for a room connector 130 (e.g., jack) on the switch (e.g., 62). The interface index number is then used to acquire the interface description. The interface description is the name of the actual port on the switch (e.g., Fa04).

Therefore, the switch port 120 for the target MAC address 125 is FaO4. By referencing the switch IP address 121 (192.168.1.3) and switch port 120 (Fa04) in the network documentation 200, the patch panel port 140 and switch port 120 to which the switch port 120 is connected can be determined. As stated above, location of the room connector 130 in the network documentation determines the physical location (e.g., room in a building) of the target MAC address 125 and thus the device (e.g., VoIP phone).

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. Accordingly, all suitable modifications and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method for locating a device connected to a network, comprising:
querying the network to determine an address associated with the device;
accessing network address information to determine a switch IP address and a switch port associated with the address of the device; and
correlating the switch IP address and switch port with a physical location of the device within the network.

2. The method of claim 1, wherein the address is an IP address and/or a MAC address.

3. The method of claim 1, wherein the correlating step comprises:
correlating the switch IP address and the switch port with a patch panel port and/or a room connector to determine the physical location of the device.

4. The method of claim 1, wherein the location of the device is monitored and updated as the device moves within the network.

5. The method of claim 1, further comprising locking the switch address if the address of the device does not match its intended location.

6. The method of claim 5, wherein the locking comprises locking a switch port if the device does not match its intended location.

7. The method of claim 6, wherein the locking comprises locking a switch IP address if the device does not match its intended location.

8. The method of claim 1, further comprising locking the switch IP address if the address of the device does not match any address in the address list.

9. The method of claim 1, further comprising:
converting a hexadecimal value of an address of a desired device in the network address information into decimal values; and
utilizing the decimal values to retrieve the patch panel port corresponding to the desired device address.

10. The method of claim 1, wherein the device is at least one of: a computer, a personal digital assistant, a fax machine, a telephone, a voice over IP telephone, an audio device or a video device.

11. The method of claim 2, wherein the room connector is an access point connector and/or a jack.

12. The method of claim 1, wherein the location of the device in the network can be found utilizing a phone number of the device.

13. A computer network system, comprising:
a switch connected to a network;
a device connected to the switch; and
a computer executing program code configured to discover a location of the device, the program code configured to:
query the network to determine an address of the device;
access network address information to determine a switch IP address and a switch port associated with the address of the device; and
correlate the switch IP address and switch port with a physical location of the device within the network.

14. The system according to claim 13, wherein the address is an IP address and/or a MAC address.

15. The system according to claim 13, wherein the correlating step in the program code comprises:
correlating the switch IP address and the switch port with a patch panel port and/or a room connector.

16. The system according to claim 13, wherein the location of the device is monitored and updated as the device moves within the network.

17. The system of claim 13, wherein the computer code is further configured to lock the switch address if the address of the device does not match its intended location.

18. The system of claim 17, wherein the computer code is configured to lock a switch port if the device does not match its intended location.

19. The system of claim 18, wherein the locking step of the computer code comprises locking a switch IP address if the device does not match its intended location.

20. The system of claim 13, wherein the locking step of the computer code comprises locking the switch IP address if the address of the device does not match any address in the address list.

21. The system of claim 13, wherein the computer code is further configured to:
convert a hexadecimal value of an address of a desired device in the network address information into decimal values; and
utilize the decimal values to retrieve the patch panel port corresponding to the desired device address.

22. The system of claim 13, wherein the device is at least one of: a computer, a personal digital assistant, a fax machine, a telephone, a voice over IP telephone, an audio device or a video device.

23. The system of claim 14, wherein the room connector is an access point connector and/or a jack.

24. The system of claim 13, wherein the location of the device in the network can be found utilizing a phone number of the device.
